(19) United States
(12) Patent Application Publication
(10) Pub. No.: US 2017/0294146 A1
(43) Pub. Date: Oct. 12, 2017

(54) THORACIC SURGERY SIMULATOR FOR TRAINING SURGEONS

(71) Applicant: KINDHEART, INC., CHAPEL HILL, NC (US)

(72) Inventor: W. Andrew GRUBBS, CHAPEL HILL, NC (US)

(21) Appl. No.: 15/478,318

(22) Filed: Apr. 4, 2017

Related U.S. Application Data
(60) Provisional application No. 62/319,911, filed on Apr. 8, 2016.

(51) Int. Cl. G09B 23/30; G09B 9/00; G09B 23/34

(52) U.S. Cl. CPC G09B 23/306; G09B 23/303; G09B 23/34; G09B 9/00

(57) ABSTRACT

A surgeon training apparatus includes an operating table and an immersion tank carried by the operating table and configured to contain liquid. A thoracic animal tissue cassette is configured to hold at least harvested animal lung tissue for surgeon training. An inflator is configured to be coupled to the harvested animal lung tissue. An actuator is configured to relatively move the thoracic animal tissue cassette between an operating position above the immersion tank and an immersed position in the liquid within the immersion tank so that the surgeon can test the harvested animal lung tissue for leaks during surgeon training. The surgeon training apparatus may be at a first location at a first geographic point and a remote surgeon station may be at a second location at a second geographic point remote from the first geographic point to allow a remote surgeon to remotely train.

### PRIORITY APPLICATION(S)

This application is based upon provisional application Ser. No. 62/319,911, filed Apr. 8, 2016, the disclosure which is hereby incorporated by reference in its entirety.

### FIELD OF THE INVENTION

This invention relates generally to surgery simulators, and more particularly, this invention relates to a surgeon training apparatus that simulates thoracic surgery using thoracic animal tissue, such as having lungs and a beating heart.

### BACKGROUND OF THE INVENTION

Surgical skill training is important before a surgeon or surgical trainee attempts surgery on live patients. New surgical procedures are constantly being developed that require both surgeons and surgical trainees to practice new surgical procedures before operating on live patients.

Historically, surgical training has been provided through apprenticeships almost exclusively offered in hospital settings. Residents performed surgery under the supervision of more experienced surgeons. The type of situations presented to the surgeon trainee was largely driven by chance as the nature and timing of situations needing surgery found in patients was not under anyone's control. This model of using a stream of situations as presented by clinical service of human patients does not provide a model for repetition until mastery. As the number of hours that residents are available for surgery has decreased, the range of surgical events presented to surgical residents has also decreased. The failure rate for surgery board certifications exams is now in the range of 26%. For specialized board certifications such as thoracic surgery, the rate has been as high as 33%.

For this reason, simulators that provide for realistic surgical environments for surgical training purposes have become increasingly valuable tools. Many known surgical training stimulators exist that use organ models or computer-generated virtual reality systems. These training simulators, however, provide limited realism and are expensive. For this reason, often times, anaesthetized animals are used for vivo training. However, ethical concerns surrounding the use of the live animals for training is a concern for some.

More recently, simulators have been developed that allow a full operative experience with cardiac surgery and with lung surgery (both open and thoracoscopic) without the use of live animals. Such lifelike simulators can use either animal (e.g., porcine) organs, or human cadaver organs for surgery education and training. The simulators use organs that have been re-animated using hydraulics, reperfusion, and computer modeling, and are then placed in a human equivalent model.

In one example, the model uses a porcine heart that is prepared with an intra-ventricular balloon in each ventricle. The balloons are inflated by a computer controlled actuator or inflator. The computer program is able to simulate the beating heart, various cardiac arrhythmias, hypo- and hypertensive states, cardiac arrest, and even placement of an intra-aortic balloon pump. The model is perfused with a washable blood substitute. When placed in a replica of the pericardial well in a mannequin, the simulation or ROSS (Ramphal Cardiac Surgery Stimulator) is capable of duplicating most aspects of cardiac surgery including all aspects of cardiopulmonary bypass, coronary artery bypass grafting both on and off bypass, aortic valve replacement, heart transplantation, and aortic root reconstruction. The computer protocols also make experience with adverse events such as accidental instillation of air into the pump circuit, aortic dissection, and sudden ventricular fibrillation after discontinuation of cardiopulmonary bypass possible.

Intra-operative alveolar air leaks (IOAL) occur in many patients after pulmonary resection and those air leaks that persist beyond a few days after surgery, often require further medical treatment and necessitate longer drainage, increase post-operative pain and infections, and create other complications, thus, increasing the hospital stay for the patient. These type of air leaks are best solved during the initial thoracic operation, often using a lung sealant. However, it has been found that surgical skill is required when working with lung sealants and it is important that surgeons be properly trained in the proper use of air leak sealants to shorten the surgery time and aid in recovery.

### SUMMARY OF THE INVENTION

A surgeon training apparatus comprises an operating table and an immersion tank carried by the operating table and configured to contain liquid. A thoracic animal tissue cassette is configured to hold at least harvested animal lung tissue for surgeon training. An inflator is configured to be coupled to the harvested animal lung tissue. An actuator is configured to relatively move the thoracic animal tissue cassette between an operating position above the immersion tank and an immersed position in the liquid within the immersion tank so that the surgeon can test the harvested animal lung tissue for leaks during surgeon training.

In an example, a mannequin shell may carry the thoracic animal tissue cassette and the actuator may be configured to raise/lower and tilt the mannequin shell. A robotic surgery station may be adjacent to the operating table and may comprise at least one surgical tool, which may comprise a lung sealant applicator in an example.

A controller may be coupled to the inflator and configured to control a pressure within the harvested animal lung tissue. In an example, the thoracic animal tissue cassette may be configured to hold harvested animal heart tissue and a blood perfusion device may be coupled to the harvested animal lung tissue and heart tissue. The harvested animal lung tissue may comprise harvested animal lung tissue and heart tissue comprises porcine tissue in a non-limiting example.

In another example, a telerobotic surgery system for remote surgeon training comprises a surgeon training apparatus at a first location at a first geographic point. The surgeon training apparatus may comprise an operating table, a robotic surgery station adjacent the operating table, and an immersion tank carried by the operating table and configured to contain liquid. A thoracic animal tissue cassette is configured to hold at least harvested animal lung tissue for surgeon training. An inflator is configured to be coupled to the harvested animal lung tissue. An actuator is configured to relatively move the thoracic animal tissue cassette between an operating position above the immersion tank at an immersed position in the liquid within the immersion tank. A remote surgeon station is at a second location at a second geographic point remote from the first geographic point. The communications network couples the robotic surgery station and remote surgeon station so that a surgeon at the remote surgeon station is able to remotely train using the harvested animal lung tissue at the surgeon training apparatus and test the harvested animal lung tissue for leaks during surgeon training.

In yet another example, the communications network may couple the actuator and remote operating station so that a surgeon at the remote surgeon station is able to remotely move the thoracic animal tissue cassette. The communications network may have a latency of not greater than 200 milliseconds in another example.

A method for training a surgeon comprises providing an operating table, an immersion tank carried by the operating table and containing a liquid, and a thoracic animal tissue cassette holding at least harvested animal lung tissue. The method further comprises inflating the harvested animal lung tissue and operating an actuator to move the thoracic animal tissue cassette between an operating position above the immersion tank and an immersed position in the liquid within the immersion tank so that the surgeon can test the harvested animal lung tissue for leaks during surgeon training.

The method may comprise manipulating at least one surgical tool at a robotic surgery station adjacent the operating table during surgical training. The at least one surgical tool may comprise a long sealant applicator. The pressure may be controlled within the harvested animal lung tissue. The thoracic animal tissue cassette may be configured to hold harvested animal heart tissue. The harvested animal lung tissue and heart tissue may comprise porcine tissue.

A telerobotic surgery method for remote surgeon training comprises providing an operating table, an immersion tank carried by the operating table and containing a liquid, and a thoracic animal tissue cassette holding at least harvested animal lung tissue. The method includes inflating the harvested animal lung tissue and operating an actuator to move the thoracic animal tissue cassette between an operating position above the immersion tank and an immersed position in the liquid within the immersion tank so that a surgeon at a remote surgeon station is able to remotely train using the harvested animal lung tissue and test the harvested animal lung tissue for leaks during surgeon training.

A communications network may couple the actuator and remote operating station so that a surgeon at the remote operating station is able to remotely move the thoracic animal tissue cassette. The communications network may have a latency of not greater than 200 milliseconds.

### BRIEF DESCRIPTION OF THE DRAWINGS

Other objects, features and advantages of the present invention will become apparent from the detailed description of the invention, which follows when considered in light of the accompanying drawings in which:

FIG. 1 is a fragmentary, block diagram of the surgeon training apparatus showing basic features in accordance with a non-limiting example.

FIG. 2 is a block diagram of a system that can be used for inflating the lungs and/or heart in accordance with a non-limiting example.

FIG. 3 shows an example of the flow of data to and from a surgeon to a surgical center that may be used in accordance with a non-limiting example.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

In accordance with a non-limiting example, a need to simulate thoracic surgery is provided on a patient undergoing robotic, video-assisted thoracoscopic surgery (VATS) or open thoracic surgery with a beating heart, a lung and blood flowing in the arterial and venous vessels and provides a surgical trainee the ability to learn to use air leak sealants on lungs so a surgical trainee or other user can test the lung tissue for leaks during surgery. Lung and heart tissue from a harvested porcine or other animal tissue is used and the harvested animal lung tissue and heart tissue is incorporated with a surgeon training apparatus to enable surgeon training with an air leak sealant. Proper use of air leak sealants on lungs has been found important in surgical operations to shorten surgery time and aid recovery.

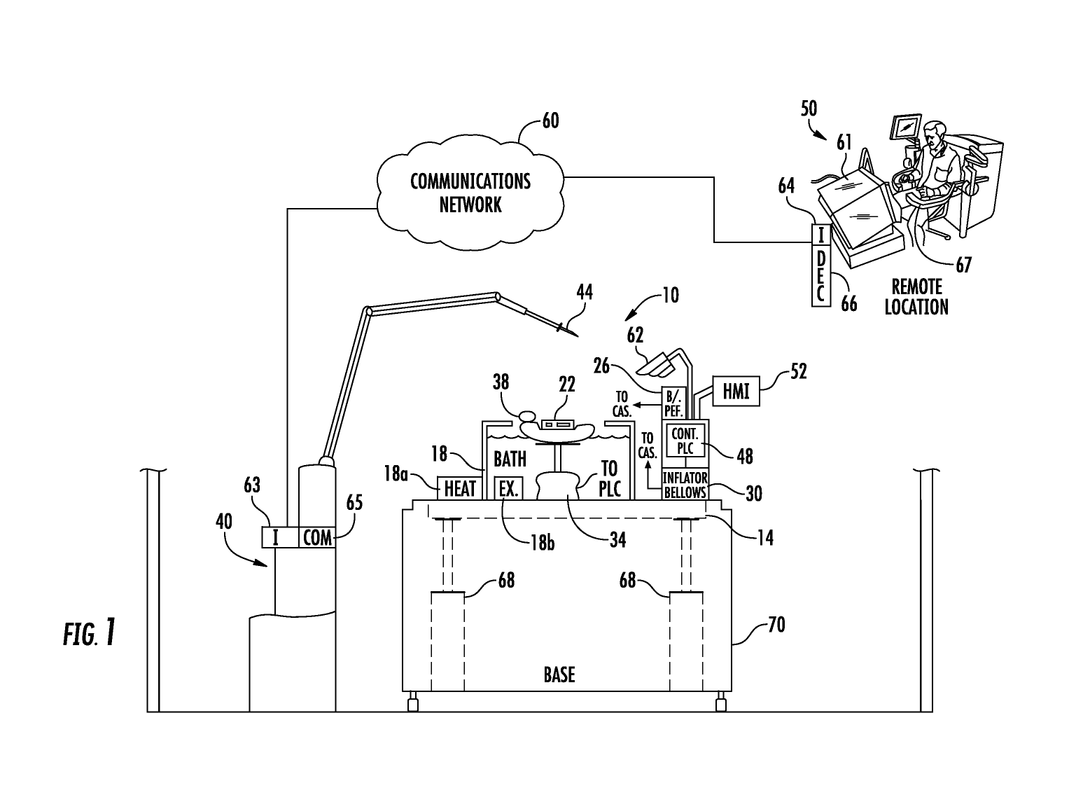

The surgeon training apparatus is shown generally at 10 in FIG. 1 and operates as a thoracic surgery simulator that simulates a patient undergoing robotic surgery, video-assisted thoroscopic surgery (VATS), laparoscopic or open thoracic surgery. It includes an operating table shown generally at 14 and an immersion tank 18 carried by the operating table and configured to contain liquid. A thoracic animal tissue cassette 22 is configured to hold at least harvested animal lung tissue for surgeon training. In an example, the thoracic animal tissue cassette is also configured to hold harvested animal heart tissue. A blood perfusion device 26 is coupled to the harvested animal tissue, i.e., the lung tissue and heart tissue in this example. In a preferred example, the harvested animal lung tissue and heart tissue is porcine tissue.

An inflator 30 is configured to be coupled to the harvested animal lung tissue to inflate the lung tissue. It can also be connected to the heart via inflatable balloons and pulsed to form a heartbeat as explained in greater detail below. An actuator 34 such as part of a lift mechanism is configured to relatively move the thoracic animal tissue cassette between an operating position above the immersion tank 18 as illustrated and an immersed position in the liquid within the immersion tank so that the surgeon can test the harvested animal lung tissue for leaks during surgeon training, for example, using a pleural air leak sealant such as the Progel™ pleural air leak sealant manufactured and sold by Bard Davol. In a preferred example, a mannequin shell 38 carries the thoracic animal tissue cassette 22. The actuator 34 as part of the lift mechanism may not only raise and lower the mannequin shell 38, but also tilt the mannequin shell to simulate real-life surgery. It is possible to form the tissue cassette to slide into a position at the immersion tank 18 and be manually locked and unlocked into position and have handles that extend over the tank to facilitate grasping.

As illustrated, a robotic surgery station 40 is positioned adjacent the operating table 14 and has at least one surgical tool 44, which in this example, is a lung sealant applicator. A controller 48 such as a PLC (Programmable Logic Controller) in this example is coupled to the inflator 30 and configured to control pressure within the harvested animal lung tissue and heart tissue and control the actuator 34 to allow vertical up and down and rotational or pivoting movement of the mannequin shell 38 that is controlled from the actuator. The surgeon training apparatus 10 allows surgeons to practice and demonstrate proficiency in their use of the air leak sealant that is indicated specifically for pleural air leaks occurring during pulmonary surgery. The apparatus may be used robotically from a tele-remote location as a remote operating or surgeon station 50 where a surgeon may remotely train as will be explained in greater detail below, or used for laparoscopic surgery or for surgery on the site location where the surgeon training apparatus is located.

The air leak sealant in an example as manufactured by Bard Davol combines Human Serum Albumin with Polyethylene Glycol to provide a sealant to visceral pleura for the treatment of intra-operative air leaks. The sealant forms a strong, flexible hydrogel usually within 15-30 seconds of application and reabsorbs in the body within 30 days to promote natural healing. It usually forms a flexible high strength sealant within five minutes. The sealant may be applied from extended spray tips that range from 1 to 11 inches in length depending on surgical requirements. It is usually intended for application to visceral pleural during an open thoracotomy after standard visceral pleural closure with, for example, sutures or staples and when visible air leaks of greater than 2 millimeters occur such as during open resection of lung parenchyma. The sealant is strong enough to withstand re-expansion of a lung within two minutes of application and is elastic to allow the lung to expand and contract during normal respiration.

The surgeon training apparatus 10 simulates a patient undergoing robotic, VATS, laparoscopic or open thoracic surgery and uses tissue organs that are harvested from preferred porcine parts, e.g., the heart and lung. The apparatus 10 simulates a realistic human patient positioned on his/her side with a beating heart, lung and blood using simulated blood flowing in the arterial and venous vessels. The simulated blood may include various additives to aid in simulating real blood, including coagulants. The apparatus provides a hands-on thoracic surgical experience using real tissue to assist in the training of medical professionals and medical device representatives in different thoracic surgical procedures and in operation of the surgical tools, such as a lung sealant applicator used for applying the air leak sealant.

The apparatus 10 may be located at a first location at a first geographic point, for example, at a hospital surgery site as a first structure or close to it to minimize travel time and maximize hands-on education time. The apparatus 10 may also be controlled remotely from the remote surgeon station 50 that also controls the robotic surgery station 40 located adjacent the operating table 14. It is possible to operate components tele-robotically for remote surgeon training using a communications network such as an internet and illustrated generally at 60 that couples the robotic surgery station 40 and other components of the surgeon training apparatus 10 with the remote surgeon station 50 so that a surgeon at the remote surgeon station 50 is able to train remotely on the harvested and animated animal tissue without being physically present.

The remote surgeon station 50 is located at a second location typically in a second structure at a second geographic point that is remote from the first geographic point to permit remote training of surgeons. The communications network 60 may have a latency of not greater than 200 milliseconds, and in another example, may have a latency of not greater than 140 milliseconds. The remote surgeon station 50 includes at least one display 61 as illustrated coupled to at least one camera 62 at the surgeon training apparatus 10 via the communications network 60. A first communications interface 63 may be coupled to the surgical training apparatus 10 and robotic surgery station 40, and a second communications interface 64 may be coupled to the remote surgeon station 50 and coupled together via the communications network 60. The first and second interfaces 63,64 may include respective data compression devices 65 and data decompression devices 66. The remote surgeon station 50 also includes at least one input device 67 as hard controls, which couples via the communications network 60 to the robotic surgery station 40 and allows a surgeon trainee to manipulate the tool 44.

Changing out the animal tissue cassette 22 usually takes less than 10 minutes and creates effectively a new patient that is prepped and ready for surgery. At the conclusion of the simulation experience, there is no medical waste and the remains of organs from the porcine parts, such as the heart, lung and the simulated or animated blood, do not require any specialized handling of waste products and removal.

An example of a surgical simulation apparatus and a tissue cassette that can be modified for use with the surgeon training apparatus 10 are disclosed in commonly assigned U.S. Patent Publication No. 2015/0024362 and Design patent application Ser. No. 29/539,690, the disclosures which are hereby incorporated by reference in their entirety. The surgeon training apparatus 10 has the ability through its controller 48 to reproduce complex heartbeat patterns in the porcine heart tissue and can be configured to produce complex breathing patterns in the porcine lung tissue. In one example, the immersion tank 18 carried by the operating table 14 is formed from a clear polycarbonate or acrylic rectangular submersion tank having a water capacity of about 7 gallons to ensure visibility around the perimeter and allow students and observers to view any simulated operation.

In operation, the thoracic animal tissue cassette 22 is connected to the controller 48 and inflator 30 via quick-connect pneumatic hoses and quick-connect intravenous lines that allow for simulated blood to flow therethrough and is positioned on the operating table. In an example, two lines are used. The thoracic animal tissue cassette 22 is carried by the mannequin shell 38, which in turn, is carried by a lift mechanism of the actuator 34, which can use as a piston, in one example, and is driven by the actuator to move the thoracic animal tissue cassette 22 and mannequin shell 38 between the operating position above the immersion tank 18 and an immersed position in the liquid within the immersion tank. A pneumatic hose may be attached to another actuator placed inside of the porcine heart as part of the harvested animal lung tissue for surgeon training and the other may be connected to one of the lungs through a commercially-available intubation tube. Intravenous (IV) bags containing simulated arterial and venous blood and may be hung from integrated IV poles and connected to the intravenous lines. Blood flow may be gravity fed and adjusted by roller clamps, as known to those skilled in the art.

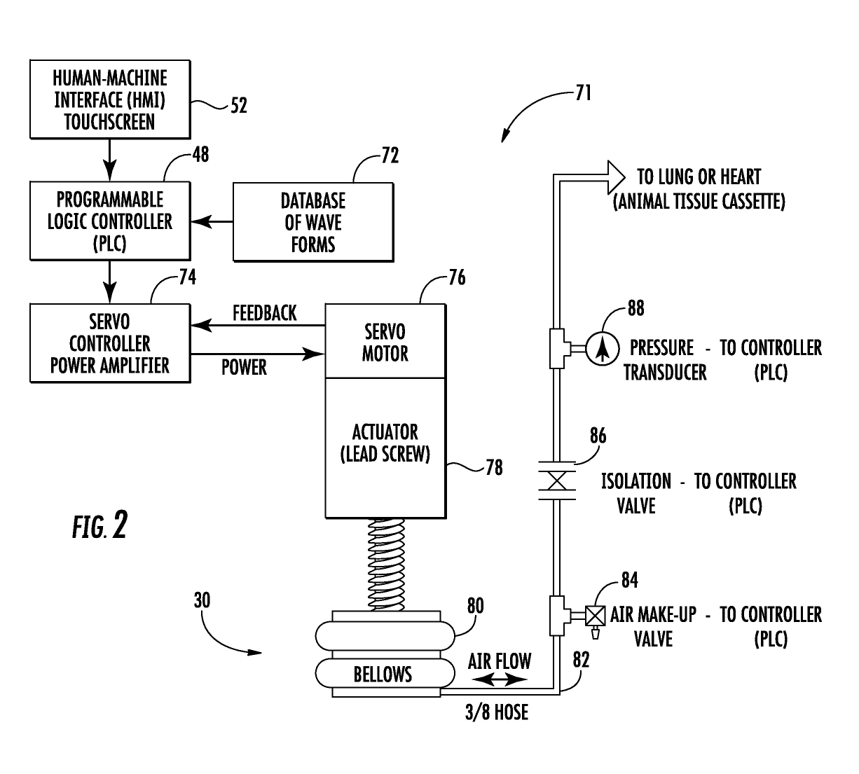

The mannequin shell 38 carrying the thoracic animal tissue cassette having the harvested animal lung tissue and heart tissue aligns these porcine organs in a human topology that approximates a patient in a left lateral decubitus position. The controller 48 includes appropriate software, including a Lung Inflation Demonstration Software programming routine that establishes the physical size characteristics of the heart and lung. For example, the inflator 30 may include a bellows pump such as further described with reference to FIG. 2 that is set to a midpoint. For the heart tissue, a pressure reading is made at this midpoint and becomes a default “0” reading. The inflator 30 may expand and lower the pressure in the heart until a pre-set pressure reading is achieved. The position of the inflator 30 or bellows in one example is noted at this low pressure reading. The inflator 30 then increases pressure until a pre-set upper pressure reading is reached. The pressure is noted at this higher pressure. This establishes the range of motion of the particular heart being used. The same routine may be performed with a lung inflator, and thus, establish the capacity of the lung. The lung is returned to its deflated state. It should be understood that a bellows type device may be used and the low pressure and high pressure marks observed for low and high pressure marks.

Apparatus that may be modified for use in the current invention are disclosed in provisional application Ser. No. 62/153,226 filed Apr. 27, 2015 as “Robotic Surgery Using a Surgical Simulator” and provisional application Ser. No. 62/219,550 filed Sep. 16, 2015 as “Surgical Simulation System,” the disclosures which are hereby incorporated by reference in their entirety. An example bellows as an inflator is described in the incorporated by reference '226 application and other components are explained briefly below.

When a heart pump is used, it is set to begin beating in a normal sinus rhythm in the range of about 60 to 90 beats per minute. During the demonstration of the air leak sealant, the heart rate remains constant, but can be changed by adjusting the rate using the touch screen of a human-machine interface (HMI) 52 having a display console as illustrated, which controls the Lung Inflator Demonstration Software via the controller 48. The thoracic animal tissue cassette 22 containing the beating heart and lung are held above the thermostatically-controlled water in the immersion tank 18 at a temperature usually about 98.6° F., corresponding to human temperature. Any appropriate locking mechanism may be used to hold the mannequin shell 38 and its thoracic animal tissue cassette 22 in a position above the immersion tank 18, such as a manual lock if a sliding or other cassette structure is used on the actuator 34 as illustrated.

In this example as illustrated, the actuator 34 moves the mannequin shell 38 and in this example the thoracic animal tissue cassette 22 vertically into and out of the liquid. A surgical trainee or other demonstration leader for training spectators will operate on the porcine lung by making incisions, suture lines or staple lines, thus, creating holes and leakage pathways in the porcine lung that are plausible and representative of those types of holes and leakage pathways commonly found in real surgery. For example, the surgeon could simulate the excision of a portion of a lung that may be cancerous or part of a lung operation that is coupled with a heart surgery.

The locking mechanism holding the mannequin shell 38 and tissue cassette 22 over the immersion tank 18 is released manually or automatically via the controller 48 and from the remote operating station 50 when a surgeon trainee is remotely training. The thoracic animal tissue cassette 22, and in this example, also the mannequin shell 38, is lowered into the immersion tank while the heart is still beating. When the lung is submerged, the lung is lightly inflated by the inflator 30 so that bubbles of air are forced out of the lung along the cuts, suture and staple lines. These leaks and the location are noted. The lung is deflated and the thoracic animal tissue cassette 22 (and mannequin shell 38 if used) containing the beating heart and lung are then raised up out of the immersion tank 18 and locked to hold the thoracic animal tissue cassette 22 and mannequin shell 38 if used out of the water.

The air leak sealant is applied to the locations of the leaks in a manner consistent with FDA guidelines used for the product. A timer may be triggered by the software via the controller 48 either automatically or by the surgical trainee or demonstration leader. The timer counts down the appropriate curing time for the air leak sealant that is estimated to be about 2 minutes at 98.6° F. When the timer indicates the sealant securing period is complete, an alarm or other notification is produced by the controller 48, for example, and the surgeon training apparatus 10 automatically begins a first inflation test where the lung is lightly inflated to a pre-set pressure. This simulation surgery may be also controlled via the human machine interface 52 such as a graphical user interface (GUI) on a display.

If the air leak sealant is holding and there is no visible delamination or separation of the air leak sealant and the lung tissue, the lightly inflated lung and beating heart on the thoracic animal tissue cassette 22 is lowered into the water using the actuator 34 or manually depending on cassette design. If there are any visible bubbles from the sealant repairs, the process is stopped and the air leak sealant is reapplied with an appropriate curing time. If there are no visible bubbles or other indication of leakage, the surgical trainee or demonstration leader may use the human machine interface 52 to start a series of preprogrammed pressure tests on the lung, with the pressure increasing at a predetermined rate. The pressure level using the inflator 30 and any pneumatic circuit to the lung may be displayed on the graphical user interface via the display as part of the human machine interface 52. If the lung is sealed and not producing bubbles, the surgical trainee or demonstration leader may begin a “torture test” of known modes of failure such as coughs and/or sneezes. It is also possible for a surgeon trainee at the remote surgeon station 50 to control this process remotely, applying the air leak sealant and testing it as described above.

The controller 48 may include stored waveforms in a waveform database that are scaled via a Digital Signal Processing (DSP) Fast Fourier Transform (FFT) and use the maximum inflation data obtained from the air leak sealant tests above. The system may operate the inflator 30 to cause the lung to cough or sneeze with increasing “amplitude” such that the final cough or sneeze is established just below the calculated and known failure point of the air leak sealant. The surgical trainee or demonstration leader may invoke a cough or sneeze that will likely cause the air leak sealant to fail and to establish that there is a range of pressures where the air leak sealant will hold. That range is not infinite and the demonstration or surgical simulation gives the surgical trainee or demonstration leader an idea of the ranges and how the air leak sealant operates under simulated surgical conditions.

The lungs will absorb a certain amount of air during any surgical training and simulation and this may be determined experimentally and factored into the scaling of the “torture test.” This test may be repeated with the current heart and lung positioned in the tissue cassette 22. Alternatively, the thoracic animal tissue cassette 22 (and mannequin shell 38 if used) may be raised out of the water and locked in an “up” position. The thoracic animal tissue cassette is disconnected and a new set of animal tissue in a new thoracic animal tissue cassette 22 loaded to repeat the process for a new surgical trainee or demonstration.

The operating table 14 may be formed as an electrically operated table with appropriate actuators 68 to allow the operating table 14 to be adjustable from as low as 22 inches to as high as 42 inches. In one example, the operating table 14 may include at least a 24 inch by 36 inch top surface such as formed from stainless steel, in one example. It may be mounted on casters with an override leveling feature to assure maximum stability and is designed preferably to be about 100 pounds, allowing it to be rolled easily by a nurse or other operating room attendant. The immersion tank 18 is formed preferably from polycarbonate or acrylic and ensures visibility around its perimeter.

The immersion tank 18 has an external heater 18a connected to the tank via flexible hoses and flows warm water into a heat exchanger 18b that is located in the bottom of the immersion tank. The heated water in the heat exchanger 18b never mixes with the water in the immersion tank 18 to avoid contamination of any heater elements by contact with the water that is in contact with the animal tissue. A thermostat may be mounted near the top of the tank to show the current and desired temperature of about 98.6° F. A plug-in suction pump may allow easy filling and draining of the immersion tank 18.

The thoracic animal tissue cassette 22 may be manufactured using different techniques and may be configured at different dimensions as described before. In one example, it is about 8 inches by 16 inches. It may be formed using Fused Deposition Modeling (FDM) techniques and three-dimensional (3-D) printing from ABS or similar material and be colored red for easy identification. The actuator 34 may be formed as a piston style lift mechanism that is manufactured using an aluminum frame inside the immersion tank 18. The thoracic animal tissue cassette 22 may be supported so it will not fall into the immersion tank without being manually or automatically released. The thoracic animal tissue cassette 22 may include handles that lift the cassette and fold back around the tank 18 so as not to obstruct the organs from being properly manipulated. This type of design would be a manual design with manually actuated locks.

The mannequin shell 38 that carries the thoracic animal tissue cassette 22, and in one example, may be an upper-body model with appropriate cut-outs and mounting devices to accept the thoracic animal tissue cassette. It is easily removable to facilitate a variety of demonstrations and can be custom designed. The thoracic animal tissue cassettes 22 has quick-connect features and may be modified for specific conditions to demonstrate specific medical procedures. The porcine organs used in the preparation of the thoracic animal tissue cassette 22 may have different size, weight and anatomical features and include the presence of naturally occurring tumors and defects. Any IV bags are usually about 500 millimeter, and in one example, two IV bags include roller clamps and standard connections for use with the thoracic animal tissue cassette 22. Each IV bag may be filled with a prepared simulated arterial or venous blood. The simulated blood is non-toxic and does not contain biologic material in one example. The thoracic animal tissue cassettes 22 may be custom prepared as a “pre-operation” preparation to replicate the more routine dissection and condition of a specific point in a surgical procedure to allow the simulation experience to focus on non-routine procedures or use of specific medical devices and products.

In one example, a heavy-duty, opaque black linear low-density polyethylene (LLDPE) bag is included with each thoracic animal tissue cassette 22 and lines the mannequin shell portion or other area that receives the cassette. When the simulation procedure is completed, the mannequin shell 38 is removed and the LLDPE bag is used to capture the disposable thoracic animal tissue cassette 22 and all expended blood and porcine tissue for a drip-free disposal. For example, the mannequin shell 38 may have an open area that carries the thoracic animal tissue cassette and is lined with the LLDPE bag.

The surgeon training apparatus 10 may include a base unit 70 as a support for the different components, including the controller 48, inflator 30, and in the example as illustrated, the operating table 14, which may be configured in size to the base unit. In an example, the base unit 70 may be integral with or located near or on the operating table 14 and formed as a steel and aluminum structure, and in one example, weighing about 150 pounds where it is integral with the operating table 14 as illustrated. The base unit 70 may be about 27 inches long, 30 inches wide, and 44 inches high and is mounted on lockable casters in one non-limiting example. It may support two independent pneumatic servo-controlled systems such as part of the inflator 30 driving either intra-ventricular actuators and be directly coupled to the bronchus to control the breathing function of the porcine lungs. It includes appropriate tubing that is connected to the thoracic animal tissue cassette and the human machine interface as a touch screen display to implement a graphical user interface. The controller 48 may include Allen-Bradley programmable logic controller (PLC) units with a PLC architecture. An integral retractable IV pole may be connected to the base unit for venous and arterial simulated blood.

As noted before and shown in greater detail in FIG. 2, an inflation/deflation system 71 includes the controller 48 that interoperates with a memory 72 having a database of waveforms, which preferably reside in a non-volatile memory such as on a memory board or card and is assessed by the controller as a PLC in this example. For heartbeats, these waveforms approximate EKG traces. With the lung functions, including coughs and sneezes, these waveforms approximate audio frequency recordings of the sound made during a cough or sneeze.

The base unit 70 may support the overall system components, including a server-controller power amplifier 74 as a high-power analog audio frequency amplifier and a servomotor 76 that includes a feedback loop between the signal fed to the amplifier and actual motion of the servomotor. The servomotor 76 may draw power from the amplifier in direct proportion to the waveform that it is being tasked to reproduce. The actuator 78 may be formed as a high speed, low-latency lead screw to convert rotational motion to linear motion and it be attached to a bellows 80 as part of the inflator 30 such as described above and further described in the incorporated by reference patent applications identified above. The bellows 80 outputs air via an air hose connection to an air hose 82 such as ⅜ hose or tube that eventually connects to a balloon placed in the porcine heart or directly to the windpipe or bronchus of the porcine lungs. The controller (PLC) 48 controls operation of the different types of valves that open when needed to begin a “breathing” and cardiac cycle. An air make-up valve 84 may be connected to the air hose 82 and isolation valves 86 may be formed as a liquid trap in a HEPA filter that prevents potentially contaminating residual porcine liquids from entering the inflator 30 and/or bellows 80 and allowing the mechanical and electrical components to decompose. The system may shut down if liquid is detected. Pressure transducers 88 provide an accurate pressure reading to the controller or PLC 48 and operate to help size the heart and lungs and prevent overfilling while scaling the waveforms. The system may include “quick connect” fittings as known to those skilled in the art to connect a hose from any pumps to the driven organ.

As noted in the incorporated by reference '226 patent application identified above, inflation and deflation of lungs of a real patient causes the rise and fall of the mediastinum. To simulate this, an appropriate volume of air or some other fluid can be used to inflate and deflate an appropriately sized and placed container hidden under the tissue to be animated with movement. For example, a respiration rate of 20 breaths per minute can be simulated by periodically expanding an air bladder such as a whoopee cushion, or an empty one-liter IV bag that is folded in half.

Rather than merely animating the tissue by causing it to rise and fall, it is possible to connect lungs to a source of gas, such as air or nitrogen, and cycle the air going into and out of the lungs in such a way as to mimic respiration. For example, a bellows or an “Ambu bag,” can be used to provide a “pulsatile” air supply. A suitable arrangement is described, for example, in U.S. Publication No. 2013/0330700, the disclosure which is hereby incorporated by reference in its entirety, and may be used with the surgeon training apparatus 10.

In one embodiment, from one to four balloons are placed within from one to four ventricles (typically with only one balloon per ventricle). The inflation and contraction of the balloon replicates a heartbeat. Anywhere from one to four balloons can used, in anywhere from one to four ventricles, depending on the type of surgery to be simulated. The balloons are inflated with air, and allowed to deflate. The inflation and deflation of the balloons causes real or fake blood to circulate through the simulated “patient,” or at least those parts of which that are exposed to the surgeon undergoing training.

By placing the balloon(s) inside of the ventricles, it is possible to reproduce reasonably and accurately the movement of the heart. The inflation of the balloon causes active expansion, and the deflation of the balloon causes passive contraction.

The addition and removal of a gas to the balloon can be controlled using the same mechanisms for moving a gas into and out of the lungs, except that the gas is moved in and out of a balloon, which has been placed inside the heart, rather than in the lungs.

In operation, the overall system 71 as used for inflating the lungs or preparing the heart is shown in FIG. 2 and has been described generally before. The human-machine interface (HMI) 52 is equipped as a touch screen and connected to the programmable logic controller (PLC) 48 as the main controller, which includes or interoperates with the database 72 of suitable waveforms. These waveforms are used to simulate different types of breathing or different types of heartbeats. For example, a waveform can be used to simulate a normal heartbeat, cardiac arrest, various arrhythmias, and a flat-line (i.e., no pulse). Similarly, a waveform can be used to simulate normal breathing, shallow breathing, coughing, sneezing, sleep apnea, choking, and the like.

The controller as a PLC 48 is attached to the servo controller 74, which includes its power amplifier. The servo controller 74 sends power to the servomotor 76, which sends feedback signals to the servo controller 74. The servomotor 76 is connected to the actuator 78, which translates energy into linear motion in this non-limiting example. This can be, for example, a lead screw, ball screw, or rocker screw. There are a number of linear energy devices enabling pumping and other functions as known to those skilled in the art.

Electromechanical actuators, which use an electric motor, can be used. Machine screw actuators may be used to convert rotary motion into linear motion, and the linear motion may move a bellows up and down.

The bellows 80 may operate as part of the inflator 30 in this example and may be incorporated with the actuator 78 to transfer pressure into a linear motion, or linear motion into pressure, depending on whether a gas is being blown into the lungs or heart, or being removed from the lungs or heart. An edge welded bellows actuator may allow a long stroke, have excellent media compatibility, and permit high temperature and pressure capabilities. Edge welded bellows may also provide flexibility in design to fit size, weight, and movement requirements and allow the movement to be driven by internal or external forces. Bellows actuators may be used in valve applications, where pressure is internal or external to the bellows. Custom flanges, end pieces and hardware can be integrated into the assembly as appropriate.

In the illustrated example, the bellows 80 is attached to the appropriately-sized hose 82, typically between one-fourth and 1 inch in diameter, more typically ⅜ or one-half inch in diameter, which allows for the passage of a gas. The hose may pass through the air make-up valve 84, the isolation valve 86, and the pressure transducer 88, any and all of which can be connected to the controller 48 using techniques known to those skilled in the art. Once the appropriate pressure is attained, the gas can pass to the lung(s) and/or heart. The actuator 80, for example, the lead screw activator can be moved in one direction to fill the heart/lungs, and in the other direction to withdraw gas from the heart/lungs.

The surgical training apparatus 10 is controlled via the controller 48, for example, a programmable logic controller as a single component, but it may in practice be distributed over several pieces of equipment. The controller 48 may provide umbilical cables to one or more pneumatic supplies. An example pneumatic supply may be a closed loop system where air flow passes into and back from the umbilical cables on a periodic basis. For example, to support a beating heart, one pneumatic supply line may have air that pulses into the pneumatic line at 78 beats per minute. Optionally, this rate may be adjustable and may be altered to simulate a heart that stops or goes into some form of distress. Inflatable elements may thus expand and contract as paced by the pulses of air. Having a closed system avoids situations where the heart or lung are over-filled. The amount of air provided by the pulse into the pneumatic line may be fine-tuned by the operator in order to adjust the simulation.

A pulsatile pump that better emulates a heartbeat than a sinusoidal oscillation of air in the pneumatic line may be included with the controller or it may receive pulsatile air from an external pulsatile pump. One suitable pulsatile pump is described in U.S. Pat. No. 7,798,815 to Ramphal et al. for a Computer-Controlled Tissue-Based Simulator for Training in Cardiac Surgical Techniques, the disclosure which is incorporated herein by reference in its entirety. Additional pneumatic supply lines at various target air pressures may be included in the umbilical cable. Any umbilical cable may include lines at ambient pressure (vented to ambient) or at a slight vacuum to allow expanded balloon-type structures to be emptied.

The controller 48 may control one or more fluids and their transported delivery via one or more pumping systems. The fluids may contain medical grade ethanol, dyes, and thickening agents. Medical grade ethanol has been found useful in maintaining the animal tissue and in making the staged animal tissue inhospitable to undesired organisms. Ethanol is useful compared to other chemicals which may be used to preserve tissue because ethanol maintains the pliability of the tissue so that it behaves like live tissue in a patient. A mixture with 40% ethanol works well, but the mixture should be made with an effort to avoid flammability when exposed to sparks or a cauterization process. Ethanol is desirable in that it does not produce a discernable odor to remind the participant that this is preserved tissue.

The incorporated by reference provisional application “Robotic Surgery Using a Surgical Simulator,” Ser. No. 62/153,226 identified above, explains in greater detail in its section entitled, “IV. Remote Control of Robotic Systems” beginning on page 37 through page 53, a telesurgery and remote training system that may be used for the surgeon training apparatus 10 and the remote surgeon station 50 as described above. That incorporated by reference section is reproduced below.

### IV. Remote Control of Robotic Systems

Telesurgery can be used in order for a surgeon to perform surgery from a distance, or to provide consultation or education to another surgeon performing a real operation, where an expert surgeon may watch watching the real operation and instruct the doctor, where the surgery is performed on a surgical simulator. One or more of the surgeons can be located at a remote location, where a robot is used to carry out the surgery, using hand movements and other input from the surgeon at the remote location via a tele-robotic unit.

The robot can move the real endoscope or other surgical device according to the movements of the surgeon performed using the input devices described above.

A simulated procedure can be taught by one surgeon to another surgeon at a remote location in real-time using a video data feed. For example, a surgeon using a real endoscope looking at the surgical simulator, with real animal organs, which, depending on the organ, can beat like a beating heart or breathe like a living set of lungs, can move the endoscope inside the “orifices” of the simulated human patient, can receive video corresponding to data transmitted electronically to a remote point (e.g., from the Mayo Clinic or via the Internet), and an expert watching the operation in real-time can show the actual doctor performing the simulated surgery how to conduct the operation, or provide particular guidance to the other surgeon performing the operation. This guidance can be provided on a display screen in the actual operating room while the surgeon is operating on the simulated patient.

A storage library can be implemented, in which a library of simulations, problems encountered, etc. are stored for later retrieval by a student or surgeon. For example, an expert surgeon teaching surgery using the simulator can simulate a biopsy or how to use a laser or particular surgical device on a simulated patient with a particular abnormality or operation to be performed. This is particularly true where organs or organ blocks are selected which include the particular abnormality.

The present invention can thus be used in a telerobotics application for teaching surgery on a simulated surgical device, such as those described herein.

Force feedback may be provided to the surgeon by the instructor, where the instructor takes over control of the robotic instruments from the student.

A virtual surgery system according to an embodiment of the present invention can be used in which an input device is used by a user to perform virtual surgery as described above. The input devices can include one or more of a mouse device, a seven dimensional joystick device, a full size simulator, etc. The input device can also one or more of include a keyboard, a standard mouse, a three dimensional mouse, a standard joystick, a seven dimensional joystick, or a full size simulator with a full size mock-up of a medical or other industrial type instrument. Additionally, any of these input devices can be used in the present invention with force feedback being performed.

The signals, originating when the surgeon operates an input device, are transmitted through a wired or wireless connection, to a processor on the robotic surgical instrument, which is then translated to a command that moves the robotic arm, and the surgical tool attached to the arm.

The control of the telerobotic system is ideally handled in a manner which minimizes latency, so there is little perceived delay between the surgeon remotely directing the movement of the tool, the movement of the tool, and the video and, optionally, audio feed back to the surgeon.

One example of a suitable telerobotic communication system is described, for example, in U.S. Patent Publication No. 2013/0226343 by Baiden. Such a system can include a teleoperation center to transmit control data and receive non-control data by wireless connection to and from a surgeon, operating one or more input devices, and indirectly to and from the actual robotic system including the robotic arms and tools attached thereto.

The device used by the surgeon can include includes a transceiver for receiving and transmitting control and non-control data, respectively, and also a repeater for relaying control data to a robotic surgical system, and relaying non-control data back to the teleoperation center. The system can also include wireless repeaters to extend the communications distance between the site where the surgeon is controlling the robotic instruments, and the site where the instruments are located.

The electronics of the system can use control-specific input/output streams, and are, ideally, low latency. The electronics are preferably designed to be high speed and fast processing and to minimize latency. The system can include at least two main communication components: the first is a long distance directional transmitter/receiver, and the second is a transceiver.

A video system can perform image processing functions for, e.g., captured endoscopic imaging data of the surgical site and/or preoperative or real time image data from other imaging systems external to the simulated patient. The imaging system outputs processed image data (e.g., images of the surgical site, as well as relevant control and patient information) to the surgeon at the surgeon's console. In some aspects the processed image data is output to an optional external monitor visible to other operating room personnel or to one or more locations remote from the operating room (e.g., a surgeon at another location may monitor the video; live feed video may be used for training; etc.).

Remote surgery (also known as telesurgery) is the ability for a doctor to perform surgery on a patient even though they are not physically in the same location. Remote surgery combines elements of robotics, cutting edge communication technology such as high-speed data connections and elements of management information systems. While the field of robotic surgery is fairly well established, most of these robots are controlled by surgeons at the location of the surgery.

Remote surgery allows the physical distance between the surgeon and the simulated patient to be immaterial. It allows the expertise of specialized surgeons to be available to students worldwide, without the need for the surgeons to travel beyond their local hospital to meet the surgeon, or to a remote site where a simulated surgical center may be. A critical limiting factor is the speed, latency and reliability of the communication system between the surgeon and the robotic instrument where simulated patient is located.

### Cloud Computing

Any communications approach which provides the desired low latency can be used, but cloud computing is preferred.

A cloud computing system is one where some part of the computing happens remotely through the internet (aka “the cloud”). In the case of robotic surgery conducted remotely, this will involve a surgeon inputting information regarding the movement of robotic equipment using essentially the same tools available to the surgeon when he or she is in the same room as the robotic surgical equipment (i.e., gimbals, controllers, foot pedals, line of sight devices, and voice commands), but sending the signals over the internet, so that the controls are translated into movement of the robotic arms at the remote site.

Simultaneously, or substantially so, video signals, showing the movement of the robotic arms, and providing a video feed of the surgery taking place, is transmitted back to the surgeon.

The data is, in effect, running on a server in a data center connected to the internet, perhaps thousands of miles away, rather than on a local computer.

In one embodiment, the cloud computing experience is perceptually indistinguishable from a local computing experience. That is, when the surgeon performs an action, the surgeon experiences the result of that action immediately, just as if the surgery was being performed in the same room as the robotic device, and can view the results on a video monitor.

In one embodiment, the cloud computing system is an “OnLive” system (now owned by Sony). The OnLive system for “interactive cloud computing” is one in which the “cloud computing” (i.e., computing on a server in the internet) is indistinguishable from what computing experience would be if the application were running entirely on a local computer. This is done by minimizing latency.

It is critically important to minimize latency, because robotic surgery requires perceptually instantaneous response times, which can otherwise be difficult to achieve, given the complexity, erratic motion and unpredictability of real-time visual imagery.

The vast majority of current services, applications and media available on the internet use existing infrastructure and its inherent limitations exceedingly well. These applications generally are those that are largely unidirectional and with loose response deadlines: they download software, content and media objects based on limited amount of user interaction. Other applications from the web download executable programs which are then run in a user's local machine environment, using the internet only for a limited exchange of data and commands. This methodology requires an end-user machine to have the full extent of computing power (e.g., processor, memory, storage and graphics) as well as entire programs to be downloaded into the local user environment. With an Interactive Cloud Computing (“ICC”) system, expensive hardware, software, data, and complex processes can stay in the data center. This reduces the need, cost, complexity and energy consumption of end user computers. Further, by sharing the central systems among many users, any negative impacts associated with those systems are divided amongst the many users.

The cloud computing system not only has to provide adequate bandwidth to allow data regarding the movement of the robotic arms, and a live video feed of the operation as it is being conducted remotely, it also has to quickly process data (using interactive, cloud-based systems) and then provide (i.e., render) the resulting audio/video in the data center, compress the audio/video, and condition the compressed audio/video to be transmitted to the end user as quickly as possible, simultaneously as the user is providing real-time feedback (via gimbals, foot pedals, mice, line-of-sight, voice control, and/or other methods of controlling the movement of the robotic arms) based on those real-time-transmitted sounds and images.

The performance metrics involve bandwidth (i.e., data throughput). Generally, the more bandwidth, the better the experience. A 100 Mbps connection is much more desirable than a 5 Mbps connection because data downloads 20 times faster. For this reason, the systems described herein preferably have a bandwidth of at least 5 Mbps, more preferably, at least about 50 Mbps, and even more preferably, at least about 100 Mbps.

That said, with ICC, as long as the bandwidth required for the resolution of the video display, audio stream, and transmission of data relative to movement of the robotic arms has been met, there may not be much need for additional bandwidth. For example, if a user has a 1280×720p@60 frame/second (fps) HDTV display and stereo audio, a 5 Mbps connection will deliver good sound and video quality, even with highly interactive content, like the control of robotic arms for a remote surgical instrument. A 10 Mbps connection will fully support 1920×1080p@60 fps HDTV, a cell phone-resolution screen can be supported with 400 Kbps, and so on.

One significant aspect of the online-computing experience is that there be constant availability of data transfer. Commercial ISP connections often are rated in terms of availability (e.g., percentage of downtime, and sometimes with further statistical guarantees). For example, one can purchase a fixed downstream connection speed, for example, rated at 1.5 Mbps, using a T1 line or a fractional T1 line, or can use a cable modem connection that provides “up to” 18 Mbps downstream when a high-reliability application (e.g., an IP telephone PBX trunk line) is at stake. Although the cable modem connection is a vastly better value most of the time, because cable modem connections are typically not offered with availability guarantees, the business may not be able to risk the loss of its phone service if the cable modem connection “goes down” or if the bandwidth drops precipitously due to congestion.

While in other uses for data transfer, availability requirements may be less stringent, and users can tolerate Internet Service Provider (“ISP”) connections that occasionally go down or are impaired (e.g., from congestion), this is not the case with telerobotics.

With telesurgery, availability is extremely important. The loss of an internet connectivity can be crippling when attempting to perform a simulated surgery, particularly where the “patient” can experience bleeding, and changes on breathing rate and heartbeat, simulating a failed surgical procedure, or an error that must quickly be corrected.

Performance metrics which are particularly relevant for telesurgery include:

1. Latency: the delay when packets transverse the network, measured using Round Trip Time (RTT). Packets can be held up in long queues, or delayed from taking a less direct route to avoid congestion. Packets can also be reordered between the transmission and reception point. Given the nature of most existing internet applications, latency is rarely noticed by users and then only when latency is extremely severe (seconds). Now, users will be noticing and complaining about latencies measured in milliseconds because of the accumulation of latency as messages route through the internet, and the immediate-response nature of interactive cloud computing.

2. Jitter: random variations in latency. Prior-technology internet applications used buffering (which increased latency) to absorb and obscure jitter. As a result, users have not noticed or cared about jitter, and the common preconception is that jitter is a technical detail that has no impact on user experience or the feasibility of provisioning internet applications. With interactive cloud computing, excessive jitter can have a significant impact on user experience and perceived performance, ultimately limiting the range of applications.

3. Packet Loss: data packets lost in transmission. In the past, almost all internet traffic was controlled by TCP (Transmission Control Protocol), which hides packet losses by asking for retransmissions without the user's knowledge. Small packet losses come with small increases in latency and reductions in bandwidth, essentially invisible to users. Large packet losses (several percent and up) felt like a “slow network” not a “broken network.” With interactive cloud computing the additional roundtrip latency delay incurred by requesting a resend of a lost packet potentially introduces a significant and noticeable lag.

4. Contention: multiple users competing for the same bandwidth on an ISP's network in excess of the network's capacity, without a fair and consistent means to share the available throughput. As applications and use of Internet infrastructure continue to grow, old assumptions about the rarity or improbability of contention are being overturned. Contention leads to exacerbation in all three areas: latency, jitter and packet loss, mentioned above.

It can be important to minimize all of these aspects.

When the surgeon performs an action on a surgical instrument connected to OnLive (e.g., moves an input device), that action is sent up through the internet to an OnLive data center and routed to a server that is controlling the robotic instrument the surgeon is using. The processor computes the movement of the robotic instrument being controlled by the input device, based on that action, then the signal is quickly compressed from the server, and the signal is translated by a processor into movement of a robotic tool. Similarly, video, and, optionally, audio feed is compressed, transmitted, decompressed, and displayed on the surgeon's video display. The signals can be decompressed using a controller (for example, a PC, Mac or OnLive MicroConsole™). The entire round trip, from the time the input device is manipulated to the time the display or TV is updated is so fast that, perceptually, it appears that the screen is updated instantly and that the surgery is actually being performed locally.

The key challenge in any cloud system is to minimize and mitigate the issue of perceived latency to the end user.

### Latency Perception

Every interactive computer system that is used introduces a certain amount of latency (i.e., lag) from the point the surgeon performs an action and then sees the result of that action on the screen. Sometimes the lag is very noticeable, and sometimes it is not noticeable. However, even when the brain perceives response to be “instantaneous”, there is always a certain amount of latency from the point the action is performed and the display shows the result of that action. There are several reasons for this. To start with, when you press a button, or otherwise activate an input device, it takes a certain amount of time for that button press to be transmitted to the processor (it may be less than a millisecond (ms) with a wired controller or as much as 10-20 ms when some wireless controllers are used, or if several are in use at once). Next, the processor needs time to process the button press. So, even if the processor responds right away to a button action, and moves the robotic arm, it may not do so for 17-33 ms or more, and it may take another 17-33 ms or more for the video capture at the surgical site to reflects the result of the action.

Depending on the system, the graphics hardware, and the particular video monitor, there may be almost no delay, to several frame times of delay. Since the data is being transmitted over the cloud, there typically is some delay sending the data to other surgeons watching and/or participating in the surgical procedure.

So, in summary, even when the system is running on a local machine, there is always latency. The question is simply how much latency. As a general rule of thumb, if a surgeon sees a response within 80 ms of an action, not only will the surgeon perceive the robotic arm as responding instantaneously, but the surgeon's performance will likely be just as good as if the latency was shorter. And, as a result, 80 ms is the desired “latency budget” for the systems described herein. That is, the system, which can be an OnLive system, has up to 80 ms to: send a controller action from the surgeon's location, through the internet to an OnLive data center, route the message to the OnLive server that controls the robotic arms, have a processor on the robotic system calculate the next movement of the robotic arm, while simultaneously outputting video and, optionally, audio feeds, which can be compressed, route the optionally compressed feeds through the internet, then decompress the feed, if it was compressed, at the surgeon's video display. Ideally, this can be carried out at video feed rate of at least 60 fps, with HDTV resolution video, over a consumer or business internet connection.

Over Cable and DSL connections, OnLive is able to achieve this if the surgeon and the remote surgical site are located within about 1000 miles of the OnLive data center. So, through OnLive, a surgeon who is 1000 miles away from a data center can perform remote surgery, and display the results of the surgery on one or more remote video displays, running on a server in the data center. Each surgeon, whether it is the surgeon or surgeons performing the simulated surgical procedure, or one or more students observing the procedure, will have the perception as if the surgery were performed locally.

### OnLive's Latency Calculations

The simplified diagram below shows the latencies encountered after a user's action in the home makes it way to an OnLive data center, which then generates a new frame of the video game and sends it back to the user's home for display. Single-headed arrows show latencies measured in a single direction. Double-headed arrows show latencies measured roundtrip.

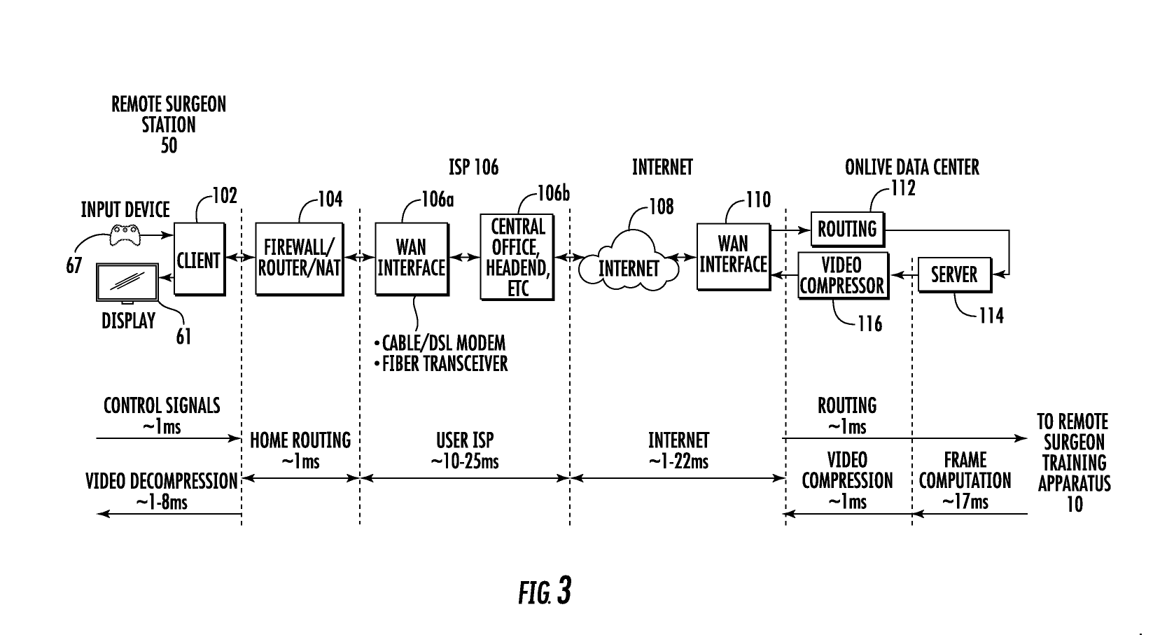

FIG. 3 shows the flow of data from the surgeon to the surgical center, via an OnLive data center. As illustrated in FIG. 3, the input device could correspond to a robotic surgeon station 52. The input device could be the controls 67 of FIG. 1 and connects to the client 102 with a connection to the display 61 and a firewall/router/NAT 104 and to the internet service provider 106 that includes a WAN interface 106a and a central office and head end 106b. It connects to the internet 103 and a WAN interface 110 that in turn connects to the OnLive data center with a routing center 112 including a router that connects to a server 114 and video compressor 116. At the client 102 video decompression occurs. This type of system is applicable for use with the telerobotic surgery system.

### ISP Latency

Potentially, the largest source of latency is the “last mile” latency through the user's Internet Service Provider (ISP). This latency can be mitigated (or exacerbated) by the design and implementation of an ISP's network. Typical wired consumer networks in the US incur 10-25 ms of latency in the last mile, based on OnLive's measurements. Wireless cellular networks typically incur much higher last mile latency, potentially over 150-200 ms, although certain planned 4G network technologies are expected to decrease latency. Within the internet, assuming a relatively direct route can be obtained, latency is largely proportional to distance, and the roughly 22 ms worst case roundtrip latency is based on about 1000 miles of distance (taking into account the speed of light through fiber, plus the typical delays OnLive has seen due to switching and routing through the internet.

Ideally, the data center and surgical center that are used will be located such that they are less than 1000 miles from each other, and from where a surgeon will be remotely accessing the robotic system. The compressed video, along with other required data, is sent through the internet back and forth from the surgeon to the robotic system. Notably, the data should be carefully managed to not exceed the data rate of the user's internet connection, as such could result in queuing of packets (incurring latency) or dropped packets.

### Video Decompression Latency

Once the compressed video data and other data is received, then it is decompressed. The time needed for decompression depends on the performance of the system, and typically varies from about 1 to 8 ms. If there is a processing-constrained situation, the system will ideally will select a video frame size which will maintain low latency.

The system typically also includes controllers coupled to the articulate arms by a network port and one or more interconnect devices. The network port may be a computer that contains the necessary hardware and software to transmit and receive information through a communication link in a communication network.

The control units can provide output signals and commands that are incompatible with a computer. The interconnect devices can provide an interface that conditions the signals for transmitting and receiving signals between the control units and the network computer.

It is to be understood that the computer and/or control units can be constructed so that the system does not require the interconnect devices. Additionally, the control units may be constructed so that the system does not require a separate networking computer. For example, the control units can be constructed and/or configured to directly transmit information through the communication network.

The system can include a second network port that is coupled to a robot/device controller(s) and the communication network. The device controller controls the articulate arms. The second network port can be a computer that is coupled to the controller by an interconnect device. Although an interconnect device and network computer are described, it is to be understood that the controller can be constructed and configured to eliminate the device and/or computer.

The communication network 60 can be any type of communication system including but not limited to, the internet and other types of wide area networks (WANs), intranets, local area networks (LANs), public switched telephone networks (PSTN), integrated services digital networks (ISDN). It is preferable to establish a communication link through a fiber optic network to reduce latency in the system. Depending upon the type of communication link selected, by way of example, the information can be transmitted in accordance with the user datagram protocol/internet protocol (UDP/IP) or asynchronous transfer mode/ATM Adaptation Layer 1 (ATM/AAL1) network protocols. The computers may operate in accordance with an operating system sold under the designation VxWorks by Wind River. By way of example, the computers can be constructed and configured to operate with 100-base T Ethernet and/or 155 Mbps fiber ATM systems.

A mentor control unit can be accompanied by a touchscreen computer and an endoscope interface computer where the touchscreen computer can be a device sold by Intuitive under the trademark HERMES. The touchscreen allows the surgeon to control and vary different functions and operations of the instruments. For example, the surgeon may vary the scale between movement of the handle assemblies and movement of the instruments through a graphical user interface (GUI) of the touchscreen. The touchscreen may have another GUI that allows the surgeon to initiate an action such as closing the gripper of an instrument.

The endoscope computer may allow the surgeon to control the movement of the robotic arm and the endoscope. Alternatively, the surgeon can control the endoscope through a foot pedal (not shown). The endoscope computer can be, for example, a device sold by Intuitive under the trademark SOCRATES. The touchscreen and endoscope computers may be coupled to the network computer by RS232 interfaces or other serial interfaces.

A control unit can transmit and receive information that is communicated as analog, digital or quadrature signals. The network computer may have analog input/output (I/O), digital I/O and quadrature interfaces that allow communication between the control unit and the network. By way of example, the analog interface may transceive data relating to handle position, tilt position, in/out position and foot pedal information (if used). The quadrature signals may relate to roll and pan position data. The digital I/O interface may relate to cable wire sensing data, handle buttons, illuminators (LEDs) and audio feedback (buzzers).

The position data is preferably absolute position information. By using absolute position information the robotic arms can still be moved even when some information is not successfully transmitted across the network. If incremental position information is provided, an error in the transmission would create a gap in the data and possibly inaccurate arm movement. The network computer may further have a screen and input device (e.g., keyboard) that allows for a user to operate the computer.

On the “patient” side, there is also a network and control computer. The controller may include separate controllers. The controller can receive input commands, perform kinematic computations based on the commands, and drive output signals to move the robotic arms and accompanying instruments to a desired position. The controller can receive commands that are processed to both move and actuate the instruments. Controller can receive input commands, perform kinematic computations based on the commands, and drive output signals' to move the robotic arm and accompanying endoscope.

Controllers can be coupled to the network computer by digital I/O and analog I/O interfaces. The computer may be coupled to the controller by an RS232 interface or other serial type interfaces. Additionally, the computer may be coupled to corresponding RS232 ports or other serial ports of the controllers. The RS232 ports or other serial ports of the controllers can receive data such as movement scaling and end effector actuation.

The robotic arms and instruments contain sensors, encoders, etc. that provide feedback information including force and position data. Some or all of this feedback information may be transmitted over the network to the surgeon side of the system. By way of example, the analog feedback information may include handle feedback, tilt feedback, in/out feedback and foot pedal feedback. Digital feedback may include cable sensing, buttons, illumination and auditory feedback. The computer can be coupled to a screen and input device (e.g. keyboard). Computers can packetize the information for transmission through the communication network. Each packet may contain two types of data, robotic data and other needed non-robotic data. Robotic data may include position information of the robots, including input commands to move the robots and position feedback from the robots. Other data may include functioning data such as instrument scaling and actuation.

Because the system transmits absolute position data the packets of robotic data can be received out of sequence. This may occur when using a UDP/IP protocol which uses a best efforts methodology. The computers are constructed and configured to properly treat any “late” arriving packets with robotic data. For example, the computer may sequentially transmit packets 1, 2 and 3. The computer may receive the packets in the order of 1, 3 and 2. The computer can disregard the second packet. Disregarding the packet instead of requesting a re-transmission of the data reduces the latency of the system. It is desirable to minimize latency to create a “real time” operation of the system.

It is preferable to have some information received in strict sequential order. Therefore the receiving computer will request a re-transmission of such data from the transmitting computer if the data is not errorlessly received. The data such as motion scaling and instrument actuation must be accurately transmitted and processed to insure that there is not an inadvertent command.

The computers can multiplex the RS232 data from the various input sources. The computers can have first-in first-out queues (FIFO) for transmitting information. Data transmitted between the computer and the various components within the surgeon side of the system may be communicated, for example, through a protocol provided by Intuitive under the name HERMES NETWORK PROTOCOL (HNP) Likewise, information may be transmitted between components on the patient side of the system in accordance with HNP.

In addition to the robotic and non-robotic data, the patient side of the system will transmit video data from the endoscope camera. To reduce latency in the system, the video data can be multiplexed with the robotic/other data onto the communication network. The video data may be compressed using conventional JPEG, etc., compression techniques for transmission to the surgeon side of the system.

Either computer can be used as an arbitrator between the input devices and the medical devices. For example, one computer can receive data from both control units. The computer can route the data to the relevant device (e.g., robot, instrument, etc.) in accordance with the priority data. For example, control unit may have a higher priority than control unit. The computer can route data to control a robot from control unit to the exclusion of data from control unit so that the surgeon at has control of the arm.

As an alternate embodiment, the computer cam be constructed and configured to provide priority according to the data in the SOURCE ID field. For example, the computer may be programmed to always provide priority for data that has the source ID from a control unit. The computer may have a hierarchical tree that assigns priority for a number of different input devices.

Alternatively, the computer can function as the arbitrator, screening the data before transmission across the network. The computer may have a priority scheme that always awards priority to one of the control units. Additionally, or alternatively, one or more of the control units may have a mechanical and/or software switch that can be actuated to give the console priority. The switch may function as an override feature to allow a surgeon to assume control of a procedure.

In operation, the system initially performs a start-up routine, typically configured to start-up with data from the consoles. The consoles may not be in communication during the start-up routine of the robotic arms, instruments, etc. therefore the system does not have the console data required for system boot. The computer may automatically drive the missing console input data to default values. The default values allow the patient side of the system to complete the start-up routine. Likewise, the computer may also drive missing incoming signals from the patient side of the system to default values to allow the control units to boot-up. Driving missing signals to a default value may be part of a network local mode. The local mode allows one or more consoles to “hot plug” into the system without shutting the system down.

Additionally, if communication between the surgeon and patient sides of the system are interrupted during operation the computer will again force the missing data to the last valid or default values as appropriate. The default values may be quiescent′ signal values to prevent unsafe operation of the system. The components on the patient side will be left at the last known value so that the instruments and arms do not move.

Once the start-up routines have been completed and the communication link has been established the surgeons can operate the consoles. The system is quite useful for medical procedures wherein one of the surgeons is a teacher and the other surgeon is a pupil. The arbitration function of the system allows the teacher to take control of robot movement and instrument actuation at any time during the procedure. This allows the teacher to instruct the pupil on the procedure and/or the use of a medical robotic system.

Additionally, the system may allow one surgeon to control one medical device and another surgeon to control the other device. For example, one surgeon-may move the instruments while the other surgeon moves the endoscope, or one surgeon may move one instrument while the other surgeon moves the other instrument. Alternatively, one surgeon may control one arm(s), the other surgeon can control the other arm(s), and both surgeons may jointly control another arm.

One or more of the control units can have an alternate communication link. The alternate link may be a telecommunication network that allows the control unit to be located at a remote location while control unit is in relative close proximity to the robotic arms, etc. For example, control unit may be connected to a public phone network, while control unit is coupled to the controller by a LAN. Such a system would allow telesurgery with the robotic arms, instruments, etc. The surgeon and patient sides of the system may be coupled to the link by network computers.

The control system can allow joint control of a single medical instrument with handles from two different control units. The control system can include an instrument controller coupled to a medical instrument. The instrument controller can minimize the error between the desired position of the medical instrument and the actual position of the instrument.

In some embodiments, a patient has image data scanned into the system, and during a simulation or a real surgery operation, a portion of the display screen shows a pre-recorded expert simulation via video tape, CDROM, etc., or a real-time tutorial by another doctor.

Telesurgery can be performed, in which a surgeon moves an input device (e.g., a full-size virtual scope or instrument) of a simulator while a robot actually performs a real operation based on the simulated motions of a surgeon at a remote location.

Telesurgery can be used in a teaching or testing embodiment, in which the virtual surgery device or other testing device questions via text and specific task questions. For example, in a medical embodiment, the virtual device might ask a test taker to go to a particular location in the anatomy and then perform a biopsy. Questions may be inserted in the test before, during or after a particular operation (such as a bronchoscopy). A multitude of tasks may be required of a student during the test procedure. The test taker may choose between different modes, such as an illustration, practice or exam mode.

In a typical operating room or training facility, several high-resolution video monitors are placed such that the surgical team can see the operation from the perspective of the operating surgeon (usually presented as a conventional 2-D image) as well as see the screen displaying the vital signs of the patient. Frequently, there are cameras positioned to record the entire operating theater to show to relative positions of the key players, such as anesthesiologists, nurses, physician assistants and training residents.

In training systems that do not use real animal tissue, computer-rendered images are displayed in lieu of actual tissue to represent the target of the surgical procedure. These images can be made to look extremely life-like. However, a trained medical professional can instantly distinguish between a computer-generated image of an operation versus a real operation performed on either living or non-living real tissue. The computer-generated image, however well-executed and made to appear as if it were moving, lacks the inherent differences that exist between multiple examples of real animals, such as those based on genetic diversity within the same species or even within the same litter.

The computer-generated image can offer substantial benefits in the training process in the same way that a well-drawn picture of an anatomical feature can help guide a surgeon to identify specific structures during the operation and during the pre- and post-operative imaging process. Specifically, drawing or rendering an anatomical feature or structure, without the naturally-occurring bleeding and spatial contortion sometimes present due to the viewing angle or viewing access, can offer a student substantial “clarity” and allow the student to learn how to translate the images found in an anatomy atlas such as Gray's Anatomy.

In one embodiment of the telerobotic simulation system described herein, the video image of the operation as seen by the surgeon (performed on animated real animal tissue) is shown on part of the “screen” (field of view) and, can be supplemented by showing a computer-generated image (still or motion video) which can presented into the field of view as a separate image or superimposed and scaled over the image of the real tissue. Additionally, other instructional material can be presented into the surgeon's field of view which can contain useful information about the operation, the tools used, other metrics of performance or information about specific products, chemicals, pharmaceuticals or procedures that may be placed in the field of view of the surgeon to derive advertising benefit, as the law allows.

The composite image that is seen in the field of view of the surgeon may be displayed onto the video monitors in the operating theater, or, the monitors may display information that supplements the training experience, such as instructional video material regarding safety issues or a checklist of items that must be present and accounted for prior to the surgery training experience beginning. For educational and study purposes, all audio and video generated from each source may be time synchronized and recorded.

As a result of students tests, reports may be issued relating to the experience a particular student had during the test, how well they did, in comparison to the correct procedures with the individuals performance, and an indication of the performance of all individuals taking these tests for a particular question. In this manner, an exam can be determined and customized for a particular company, for example. In another embodiment, the Medical Examination Board can identify different test questions by case, one time individual performance, cumulative performance by an individual, etc., and can provide different levels of difficulty. The virtual surgery system of the present invention or other test taking device not related to surgery or medical applications can include training, test taking and records archiving abilities (for example, in a medical context this archiving can relate to a patient's medical records).

In an embodiment, it is possible to use live patients and telerobotic surgery. As latency issues are solved, this becomes possible.

All references referred to herein are hereby incorporated by reference for all purposes.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A surgeon training apparatus comprising:
an operating table;
an immersion tank carried by said operating table and configured to contain liquid;
a thoracic animal tissue cassette configured to hold at least harvested animal lung tissue for surgeon training;
an inflator configured to be coupled to said harvested animal lung tissue; and
an actuator configured to relatively move said thoracic animal tissue cassette between an operating position above said immersion tank and an immersed position in the liquid within said immersion tank so that the surgeon can test the harvested animal lung tissue for leaks during surgeon training.

2. The surgeon training apparatus according to claim 1 further comprising a mannequin shell carrying said thoracic animal tissue cassette.

3. The surgeon training apparatus according to claim 2 wherein said actuator is configured to raise/lower and tilt said mannequin shell.

4. The surgeon training apparatus according to claim 1 comprising a robotic surgery station adjacent said operating table and comprising at least one surgical tool.

5. The surgeon training apparatus according to claim 4 wherein said at least one surgical tool comprises a lung sealant applicator.

6. The surgeon training apparatus according to claim 1 comprising a controller coupled to said inflator and configured to control a pressure within the harvested animal lung tissue.

7. The surgeon training apparatus according to claim 1 wherein said thoracic animal tissue cassette is configured to hold harvested animal heart tissue.

8. The surgeon training apparatus according to claim 7 comprising a blood perfusion device configured to be coupled to the harvested animal lung tissue and heart tissue.

9. The surgeon training apparatus according to claim 7 wherein the harvested animal lung tissue and heart tissue comprises porcine tissue.

10. A telerobotic surgery system for remote surgeon training and comprising:
a surgeon training apparatus at a first location at a first geographic point, said surgeon training apparatus comprising:
an operating table;
an immersion tank carried by said operating table and configured to contain liquid;
a thoracic animal tissue cassette configured to hold at least harvested animal lung tissue for surgeon training;
an inflator configured to be coupled to said harvested animal lung tissue; and
an actuator configured to relatively move said thoracic animal tissue cassette between an operating position above said immersion tank and an immersed position in the liquid within said immersion tank;
a remote surgeon station at a second location at a second geographic point remote from the first geographic point; and
a communications network coupling said robotic surgery station and remote surgeon station so that a surgeon at the remote surgeon station is able to remotely train using said harvested animal lung tissue at said surgeon training apparatus and test the harvested animal lung tissue for leaks during surgeon training.

11. The surgeon training apparatus according to claim 10 wherein said communications network couples said actuator and remote surgeon station so that a surgeon at the remote surgeon station is able to remotely move said thoracic animal tissue cassette.

12. The surgeon training apparatus according to claim 10 wherein said communications network has a latency of not greater than 200 milliseconds.

13. The surgeon training apparatus according to claim 10 further comprising a mannequin shell carrying said thoracic animal tissue cassette.

14. The surgeon training apparatus according to claim 13 wherein said actuator is configured to raise/lower and tilt said mannequin shell.

15. The surgeon training apparatus according to claim 10 comprising a robotic surgery station adjacent said operating table and comprising at least one surgical tool.

16. The surgeon training apparatus according to claim 15 wherein said at least one surgical tool comprises a lung sealant applicator.

17. The surgeon training apparatus according to claim 10 comprising a controller coupled to said inflator and configured to control a pressure within the harvested animal lung tissue.

18. The surgeon training apparatus according to claim 10 wherein said thoracic animal tissue cassette is configured to hold harvested animal heart tissue.

19. The surgeon training apparatus according to claim 18 comprising a blood perfusion device to be coupled to the harvested animal lung tissue and heart tissue.

20. The surgeon training apparatus according to claim 18 wherein the harvested animal lung tissue and heart tissue comprises porcine tissue.

21. A method for training a surgeon, comprising:
providing an operating table, an immersion tank carried by the operating table and containing a liquid, and a thoracic animal tissue cassette holding at least harvested animal lung tissue;
inflating the harvested animal lung tissue; and
operating an actuator to move the thoracic animal tissue cassette between an operating position above the immersion tank and an immersed position in the liquid within the immersion tank so that the surgeon can test the harvested animal lung tissue for leaks during surgeon training.

22. The method according to claim 21 comprising manipulating at least one surgical tool at a robotic surgery station adjacent the operating table during surgical training.

23. The method according to claim 22 wherein the at least one surgical tool comprises a lung sealant applicator.

24. The method according to claim 21 comprising controlling the pressure within the harvested animal lung tissue.

25. The method according to claim 21 wherein the thoracic animal tissue cassette is configured to hold harvested animal heart tissue.

26. The method according to claim 25 wherein the harvested animal lung tissue and heart tissue comprises porcine tissue.

27. A telerobotic surgery method for remote surgeon training and comprising:
providing an operating table, an immersion tank carried by the operating table and containing a liquid, and a thoracic animal tissue cassette holding at least harvested animal lung tissue;
inflating the harvested animal lung tissue; and
operating an actuator to move the thoracic animal tissue cassette between an operating position above the immersion tank and an immersed position in the liquid within the immersion tank so that a surgeon at a remote surgeon station is able to remotely train using the harvested animal lung tissue and test the harvested animal lung tissue for leaks during surgeon training.

28. The method according to claim 27 wherein a communications network couples the actuator and remote operating station so that a surgeon at the remote operating station is able to remotely move the thoracic animal tissue cassette.

29. The method according to claim 27 comprising manipulating at least one surgical tool at a robotic surgery station adjacent the operating table during surgical training.

30. The method according to claim 29 wherein the at least one surgical tool comprises a lung sealant applicator.

31. The method according to claim 27 comprising controlling the pressure within the harvested animal lung tissue.

32. The method according to claim 27 wherein the thoracic animal tissue cassette is configured to hold harvested animal heart tissue.

33. The method according to claim 32 wherein the harvested animal lung tissue and heart tissue comprises porcine tissue.
